(19) United States
(12) Patent Application Publication
(10) Pub. No.: US 2011/0246388 A1
(43) Pub. Date: Oct. 6, 2011

(54) SYSTEM AND METHOD FOR PROVIDING FINANCIAL ASSET PRICING CHART WITH AGGREGATED, RANKED AND FILTERED ARTICLES

(75) Inventor: Tony Zhang, Hillsborough, CA (US)

(73) Assignee: KALENGO LLC, Hillsborough, CA (US)

(21) Appl. No.: 12/753,921

(22) Filed: Apr. 5, 2010

(51) Int. Cl. G06Q 40/00

(52) U.S. Cl. 705/36 R

(57) ABSTRACT

A system and a method for rendering a graphical chart of time and pricing data of financial assets marked by indicators corresponding to related articles of information and events, and adapted to communicate with a client, wherein the articles of information and events are ranked and filtered based on a combination of multiple automatic machine ranking and user-assigned ranking algorithms.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention generally relates to systems and methods for displaying information related to financial assets including but not limited to publicly traded securities, equity funds, stock market indexes, bonds, and other financial instruments. More specifically, the display of information includes time-pricing data of the financial assets in graphical format, and articles including but not limited to past, present, and future news, analytics results, calculation results, price predictions, signals on price movement, portfolio monitors, alerts, blogs, activity streams, and any time series events related to the financial assets.

### BACKGROUND

Currently, there are a number of software applications and Internet web sites that retrieve historical and real-time stock pricing data and display the pricing data in graphical chart format. Many of these software applications and Internet web sites also display lists of relevant news articles and event notices along with their graphical charts.

However, a problem common to these software applications and Internet web sites is that the displayed news articles and event notices are disjoint and not correlated to each other. They are often irrelevant to the user's objectives in the use of the graphical chart and the user's overall financial strategy. Without any selection and filtering, the cumulated large volume of information could overwhelm the user and rendered it useless.

Even where some of these software applications and web sites do rank and filter the news articles and event notices, their ranking systems are based on predefined algorithms executed by computer processors without any input of subjective decisions by the users. The resulting ranking thus cannot be individualized according to each user's preference, as such the relevancy of the news articles and event notices to the user's objectives in the use of the information and overall financial strategy is not consistent across the entire user base. This is the general area that embodiments of the present invention are designed to address. The present invention solves these problems by employing multiple ranking schemes to rank and filter the news articles and event notices. The ranking schemes include several machine-based algorithms and user-based subjective selections. The net results are more relevant and more digestible quantity of news articles and event notices.

Furthermore, these software applications and web sites are limited to handling news articles and blogs, and they do not provide predicted or projected future pricing data and events set to occur in future dates. The present invention, on the other hand, can rank, filter, and display articles including but not limited to past, present, and future news, news at multiple levels such as the macro-economic level, global level, regional level, sector level, industry level, and asset class level, technical analysis, analytics results, calculation results, price predictions, signals on price movement, portfolio monitors, alerts, blogs, activity streams, and any time series events related to the financial assets.

### SUMMARY

Disclosed herein is a system for rendering, by a server computer, a user-interactive graphical chart of time and pricing data of financial assets as requested by a user using a client computing device. The chart is marked by indicators corresponding to related articles of information, past, present, and future events at positions corresponding to their time of publication or occurrences. The marked chart is transmitted to the user's client computing device along with the related articles of information and events for display.

In accordance with various embodiments, the system employs a number of ranking and filtering schemes in selecting the articles of information and events to be presented to the user. The ranking schemes include those that are computed automatically by one or more processors, and those that are assigned by a single or a community of human users.

In accordance with various embodiments, the system allows users of the system to rank the importance, relevancy, popularity, and credibility of the articles of information and events. A user can tag and write comment for the articles. The action of tagging means assigning a referencing indicator to an article such that the article can be quickly located and retrieved in a future time. A user can also subscribe to the source of an article such that the user is allowed access to and be alerted for other articles published by the source. These actions performed by the users are recorded by the system and are used in the calculation of the rankings of the articles. Therefore, the users are not mere passive viewers, but also participants in the system.

In accordance with an embodiment, the ranking of an article of information or event is based on an algorithm that is the aggregate of a relevance ranking, an importance ranking, a popularity ranking, and a credibility ranking of the article of information or event. Each of the four rankings is weighted according to the configurable settings of the aggregated ranking algorithm.

### BRIEF DESCRIPTION OF THE DRAWINGS

FIG. 1 shows an illustration of a typical system where a user, through a client device, makes requests for financial asset information from a server to be displayed on the client device.

FIG. 2 shows an illustration of one embodiment of the display of the marked graphical chart of time and pricing data of the financial assets along with the ranked and filtered articles of information and events.

FIG. 3 shows an illustration of the steps performed by one embodiment of the system in rendering a graphical chart of time and pricing data of financial assets marked by indicators.

FIG. 4 shows an illustration of the steps performed by another embodiment of the system in rendering a graphical chart of time and pricing data of financial assets marked by indicators.

FIG. 5 shows the algorithms used to calculate the ranking of the articles of information and events.

### DETAILED DESCRIPTION

Disclosed herein is a system for rendering, by a server computer, a user-interactive graphical chart of time and pricing data of financial assets as requested by a user using a client computing device. Said financial assets include but are not limited to publicly traded securities, equity funds, stock market indexes, bonds, derivatives, and other financial instruments. The chart is marked by indicators corresponding to related articles of information, past, present, and future events at positions corresponding to their time of publication or occurrences. The marked chart is transmitted to the user's client computing device along with the related articles of information and events for display.

In accordance with various embodiments, the system employs a number of ranking and filtering schemes in selecting the articles of information and events to be presented to the user. The ranking schemes include those that are computed automatically by one or more processors, and those that are assigned by a single or a community of human users.

In accordance with various embodiments, the system allows users of the system to rank the importance, relevancy, popularity, and credibility of the articles of information and events. A user can tag and write comment for the articles. The action of tagging means assigning a reference to an article such that the article can be quickly located and retrieved in a future time. A user can also subscribe to the source of an article such that the user is allowed access to and be alerted for other articles published by the source. These actions performed by the users are recorded by the system and are used in the calculation of the rankings of the articles. Therefore, the users are not mere passive viewers, but also active participants of the system.

In accordance with an embodiment, the ranking of an article of information or event is based on an algorithm that is the aggregate of a relevance ranking, an importance ranking, a popularity ranking, and a credibility ranking of the article of information or event. Each of the four rankings is weighted according to the configurable settings of the aggregated ranking algorithm.

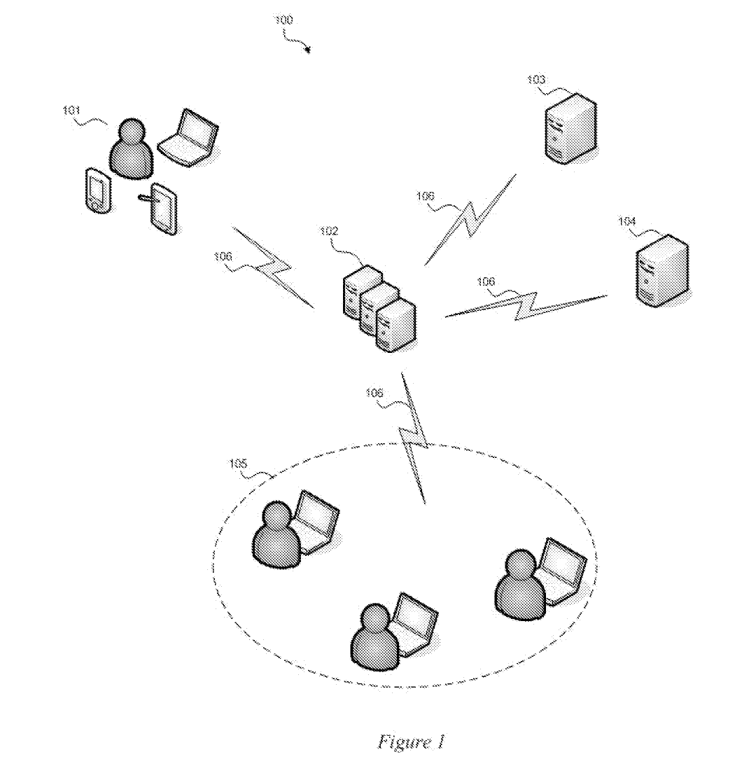

FIG. 1 shows an illustration of a typical system where a user 101, through the use of one of client devices, makes a request for financial asset information to a server application running at a server or cluster of servers 102 to be displayed on the client device. The client device can be a conventional general purpose desktop or laptop computer, personal digital assistant, smart mobile phone, or any computing device with graphics display capability and is capable of processing computer data signals conforming to common data transmission protocols such as TCP/IP, HTTP, and HTML. The requests and responses between the client device and the server or cluster of servers 102 is transmitted through wired and/or wireless communication medium 106. One such communication medium is the Internet. Other users 105 interact with the server application running at the server or cluster of servers 102 by requesting and using financial asset pricing charts, ranking the importance, relevancy, and popularity of the articles of information and events, tagging and writing comments for the articles, and/or subscribing to the sources of the articles. The server application running at the server or cluster of servers 102 retrieves from other internal and/or external servers 103 and 104 for the requested financial assets' pricing data, articles of information and events, and rankings of the articles by those internal and/or external servers.

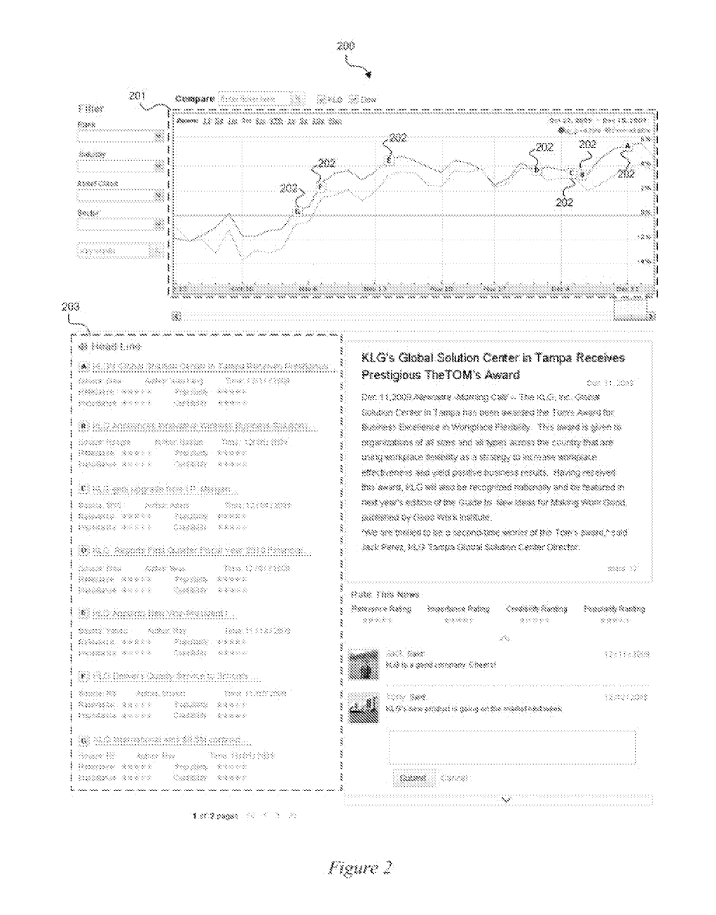

FIG. 2 shows an illustration of one embodiment of the display of the marked graphical chart of time and pricing data of the financial assets along with the ranked and filtered articles of information and events. As shown in FIG. 2, a graphical chart 201 is showing multiple trends plotted from the historical and present pricing data of the requested financial assets. In other embodiments, the pricing data used to plot the trend can include predicted and projected future pricing data of the requested financial assets. The prediction or projection of future pricing can be achieved by trend analysis of the historical time-pricing data, option price, or other derivative prices of the financial asset. Indicators 202 representing the articles of information and events related to the underlying financial asset of a pricing trend are positioned according to the articles' publication dates. The corresponding articles are listed in the lower left column 203.

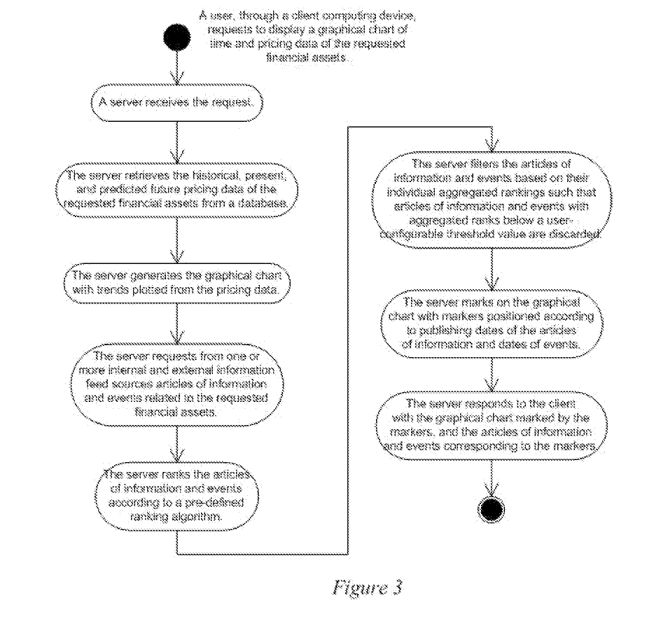

FIG. 3 shows an illustration of the steps performed by one embodiment of the system in rendering a graphical chart of time and pricing data of financial assets marked by indicators. In this embodiment, a server receives a user's request to display a graphical chart of financial asset time and pricing data. The server generates the graphical chart by first retrieving the historical, present, predicted and projected pricing data from a database; then plots the trends on the chart. The server also retrieves from one or more internal and external information feed sources articles of information and events related to the financial assets; ranks and filters the articles. This process step of retrieving, ranking, and filtering the articles is performed on demand upon the server receiving the user's request. The filtering of the articles is based on their individual aggregated rankings such that articles with aggregated ranks below a user-configurable threshold value are discarded. The server then places indicators on the graphical chart in accordance to the times and dates of the ranked and filtered articles; and finally responds to the user with the marked graphical chart along with the ranked and filtered articles of information and events.

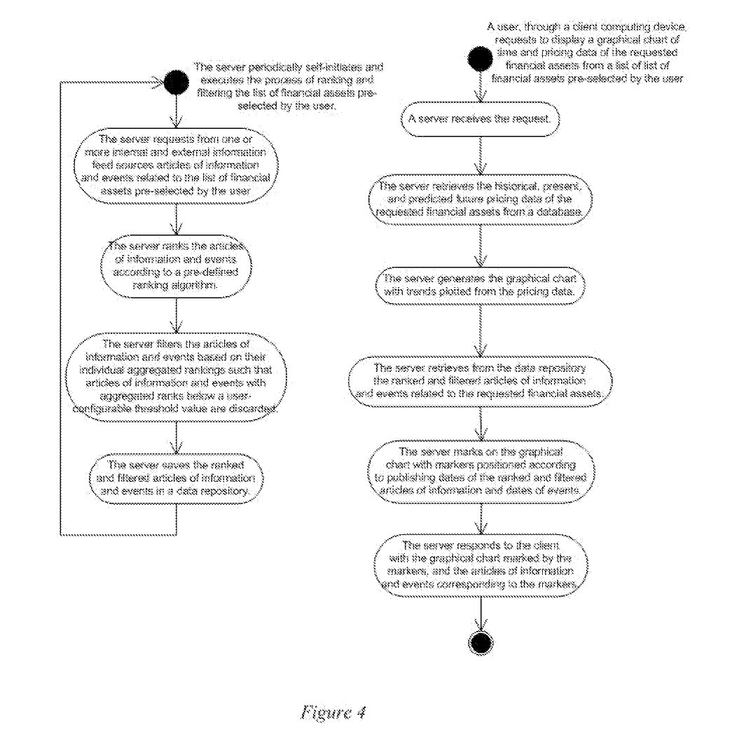

FIG. 4 shows an illustration of the steps performed by another embodiment of the system in rendering a graphical chart of time and pricing data of financial assets marked by indicators. In this embodiment, a server receives a user's request to display a graphical chart of financial asset time and pricing data. The server generates the graphical chart by first retrieving the historical, present, predicted and projected pricing data from a database; then plots the trends on the chart. Separately, the server periodically self-initiates and executes a separate process of retrieving from one or more internal and external information feed sources articles of information and events related to a list of financial assets pre-selected by the user, ranks and filters the retrieved articles such that the resulting ranked and filtered articles are readily available by the time the user requests for the graphical chart of one or more of the pre-selected financial asset. The filtering of the articles is based on their individual aggregated rankings such that articles with aggregated ranks below a user-configurable threshold value are discarded. The server then places indicators on the graphical chart in accordance to the times and dates of the ranked and filtered articles; and finally responds to the user with the marked graphical chart along with the ranked and filtered articles of information and events.

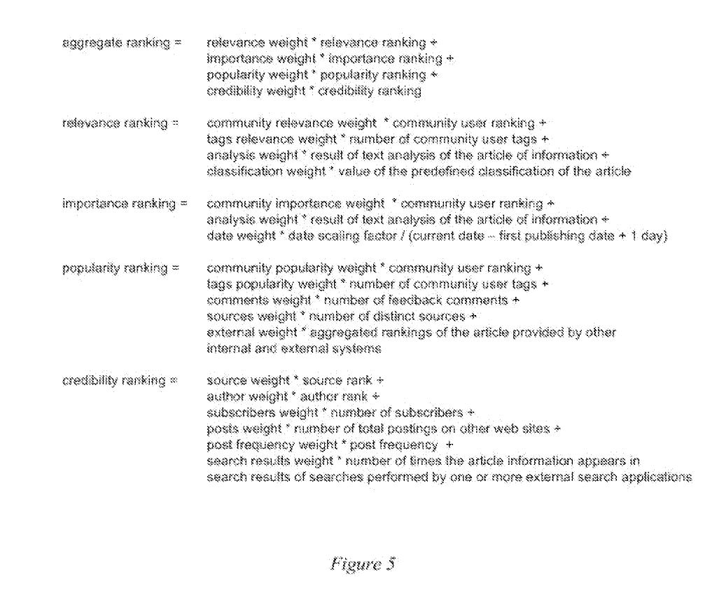

FIG. 5 shows the algorithms used to calculate the ranking of the articles of information and events. As shown in FIG. 5, the relevance ranking is calculated from weighted factors comprising: community user ranking, number of community user tags, result of text analysis of the article of information, and value of predefined classification of the article of information or event. The importance ranking is calculated from weighted factors comprising: community user ranking, result of text analysis of the article of information, and number of days since publication of the article of information. The popularity ranking is calculated from weighted factors comprising: community user ranking, number of community user tags, number of feedback comments, number of distinct sources the article of information or event appears in, and aggregated rankings of the article of information or event provided by one or more other internal or external systems. The credibility ranking is calculated from weighted factors comprising: source, author, number of subscribers, number of total postings on other web sites, post frequency, and number of times the article of information appears in search results of searches performed by one or more external search applications.

The present invention may be implemented using general purpose or specialized computers or microprocessors programmed according to the teachings of the present disclosure. Computer instructions or software codes running in the general purpose or specialized computers or microprocessors can readily be prepared by partitioners skilled in the software art based on the teachings of the present disclosure.

In some embodiments, the present invention includes a computer storage medium having computer instructions or software codes stored therein which can be used to program a computer or microprocessor to perform any of the processes of the present invention. The storage medium can include, but is not limited to, floppy disks, optical discs, Blu-ray Disc, DVD, CD-ROMs, and magneto-optical disks, ROMs, RAMs, flash memory devices, or any type of media or device suitable for storing instructions, codes, and/or data.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for rendering a graphical chart of time and pricing data of financial assets marked by indicators corresponding to related articles of information and events, and adapted to communicate with a client device, comprising:
a server to perform a rendering process in response to a request from the client device to display the graphical chart of time and pricing data of the financial assets requested;
wherein the server
retrieves historical, present, predicted and projected future pricing data of the financial assets from a database,
generates the graphical chart with trends plotted from the historical, present, predicted and projected future pricing data,
requests and receives articles of information and events related to the financial assets from a multiplicity of information feed sources,
ranks the articles of information and events,
filters the articles of information and events based on their individual aggregated rankings such that articles of information and events with aggregated ranks below a user-configurable threshold value are discarded,
marks on the graphical chart with indicators positioned according to publishing dates of the articles of information and dates of events, and
responds to the client with the graphical chart marked by the indicators, and the articles of information and events corresponding to the indicators;
wherein the dates of events can be of future dates; and
wherein the aggregate ranking of an article of information or event is calculated from a multiplicity of weighted configurable sub-rankings.

2. A system according to claim 1, wherein said multiplicity of weighted configurable sub-rankings comprises of rankings that are computed automatically by one or more processors and rankings that are assigned by one or more human users.

3. A system according to claim 1, wherein said multiplicity of weighted configurable sub-rankings include a relevance ranking of the article of information or event; wherein said relevance ranking is calculated from weighted factors comprising: community user ranking, number of community user tags, result of text analysis of the article of information, and value of predefined classification of the article of information or event.

4. A system according to claim 1, wherein said multiplicity of weighted configurable sub-rankings include an importance ranking of the article of information or event; wherein said importance ranking is calculated from weighted factors comprising: community user ranking, result of text analysis of the article of information, and number of days since publication.

5. A system according to claim 1, wherein said multiplicity of weighted configurable sub-rankings include a popularity ranking of the article of information or event; wherein said popularity ranking is calculated from weighted factors comprising: community user ranking, number of community user tags, number of feedback comments, and number of distinct sources the article of information or event appears in.

6. A system according to claim 5, wherein said weighted factors further comprising aggregated rankings of the article of information or event provided by one or more other internal or external systems.

7. A system according to claim 1, wherein said multiplicity of weighted configurable sub-rankings include a credibility ranking of the article of information or event; wherein said credibility ranking is calculated from weighted factors comprising: source, author, number of subscribers, number of total postings on other web sites, post frequency, and number of times the article of information appears in search results of searches performed by one or more external search applications.

8. A system according to claim 1, wherein said multiplicity of weighted configurable sub-rankings include a weighted relevance ranking of the article of information or event, a weighted importance ranking of the article of information or event, a weighted popularity ranking of the article of information or event, and a weighted credibility ranking of the article of information or event;
wherein the relevance ranking is calculated from weighted factors comprising: community user ranking, number of community user tags, result of text analysis of the article of information, and value of predefined classification of the article of information or event;
wherein the importance ranking is calculated from weighted factors comprising: community user ranking, result of text analysis of the article of information, and number of days since publication;
wherein the popularity ranking is calculated from weighted factors comprising: community user ranking, number of community user tags, number of feedback comments, number of distinct sources the article of information or event appears in, and aggregated rankings of the article of information or event provided by one or more other external systems; and
wherein the credibility ranking is calculated from weighted factors comprising: source, author, number of subscribers, number of total postings on other web sites, post frequency, and number of times the article of information appears in search results of searches performed by one or more external search applications.

9. A system according to claim 1, wherein said graphical chart is user interactive.

10. A system according to claim 1, wherein said graphical chart has a time axis that extends from at least the earliest of dates of the pricing data, publishing dates of the articles of information, and dates of events to the latest dates of the pricing data, publishing dates of the articles of information, and dates of events.

11. A method performed by one or more computer processors for rendering a graphical chart of time and pricing data of financial assets marked by indicators corresponding to related to related articles of information and events, comprising the steps of:
retrieving historical, present, predicted and projected future pricing data of the financial assets from a database,
generating the graphical chart with trends plotted from the historical, present, predicted and projected future pricing data,
requesting and receiving articles of information and events related to the financial asset from a multiplicity of information feed sources,
ranking the articles of information and events,
filtering the articles of information and events based on their individual aggregated rankings such that articles of information and events with aggregated ranks below a user-configurable threshold value are discarded,
marking on the graphical chart with indicators positioned according to publishing dates of the articles of information and events, and
displaying the graphical chart marked by the indicators, and the articles of information and events corresponding to the indicators.
wherein the dates of events can be of future dates; and
wherein the aggregate ranking of an article of information or event is calculated from a multiplicity of weighted configurable sub-rankings.

12. A system according to claim 10, wherein said multiplicity of weighted configurable sub-rankings comprises of rankings that are computed automatically by one or more processors and rankings that are assigned by one or more human users.

13. A method according to claim 11, wherein said multiplicity of weighted configurable sub-rankings include a relevance ranking of the article of information or event; wherein said relevance ranking is calculated from weighted factors comprising: community user ranking, number of community user tags, result of text analysis of the article of information, and value of predefined classification of the article of information or event.

14. A method according to claim 11, wherein said multiplicity of weighted configurable sub-rankings include an importance ranking of the article of information or event; wherein said importance ranking is calculated from weighted factors comprising: community user ranking, result of text analysis of the article of information, and number of days since publication.

15. A method according to claim 11, wherein said multiplicity of weighted configurable sub-rankings include a popularity ranking of the article of information or event; wherein said popularity ranking is calculated from weighted factors comprising: community user ranking, number of community user tags, number of feedback comments, and number of distinct sources the article of information or event appears in.

16. A method according to claim 15, wherein said weighted factors further comprising aggregated rankings of the article of information or event provided by one or more other internal or external systems.

17. A method according to claim 11, wherein said multiplicity of weighted configurable sub-rankings include a credibility ranking of the article of information or event; wherein said credibility ranking is calculated from weighted factors comprising: source, author, number of subscribers, number of total postings on other web sites, post frequency, and number of times the article of information appears in search results of searches performed by one or more external search applications.

18. A method according to claim 11, wherein said multiplicity of weighted configurable sub-rankings include a weighted relevance ranking of the article of information or event, a weighted importance ranking of the article of information or event, a weighted popularity ranking of the article of information or event, and a weighted credibility ranking of the article of information or event;
wherein the relevance ranking is calculated from weighted factors comprising: community user ranking, number of community user tags, result of text analysis of the article of information, and value of predefined classification of the article of information or event;
wherein the importance ranking is calculated from weighted factors comprising: community user ranking, result of text analysis of the article of information, and number of days since publication;
wherein the popularity ranking is calculated from weighted factors comprising: community user ranking, number of community user tags, number of feedback comments, number of distinct sources the article of information or event appears in, and aggregated rankings of the article of information or event provided by one or more other external systems; and
wherein the credibility ranking is calculated from weighted factors comprising: source, author, number of subscribers, number of total postings on other web sites, post frequency, and number of times the article of information appears in search results of searches performed by one or more external search applications.

19. A method according to claim 11, wherein said graphical chart is user interactive.

20. A method according to claim 11, wherein said graphical chart has a time axis that extends from at least the earliest of dates of the pricing data, publishing dates of the articles of information, and dates of events to the latest dates of the pricing data, publishing dates of the articles of information, and dates of events.
